(19) United States
(12) Patent Application Publication
(10) Pub. No.: US 2017/0327100 A1
(43) Pub. Date: Nov. 16, 2017

(54) BRAKING APPARATUS FOR A VEHICLE

(71) Applicant: The Goodyear Tire & Rubber Company, Akron, OH (US)

(72) Inventors: Guy WIESEN, Stegen (LU); Thorsten Alan GREIS, Pluwig (DE); Robert BESCH, Metzig (LU); Thierry BLEES, Rombach-Mart (LU); Marc Bernard Peter FAYMONVILLE, Grevenknapp (LU); David LLORENTE GARCIA, Luxembourg (LU)

(21) Appl. No.: 15/169,810

(22) Filed: Jun. 1, 2016

Related U.S. Application Data
(60) Provisional application No. 62/336,917, filed on May 16, 2016.

(51) Int. Cl. B60T 13/40; B60T 7/04

(52) U.S. Cl. CPC B60T 13/40; B60T 7/042; B60T 2220/04

(57) ABSTRACT

A brake system performs a repeatable brake operation of a vehicle. The brake system includes a main unit having an electrical power circuit, a micro programmable logic controller, an air compressor, a compressed air tank, a pressure regulator, a solenoid valve, and a pneumatic control circuit, a driver control box for controlling the system, and a pneumatic cylinder for performing the repeatable brake operation, the pneumatic cylinder being attached to a brake pedal.

### FIELD OF INVENTION

The present invention relates to a braking apparatus for an automotive vehicle.

### BACKGROUND OF THE INVENTION

One conventional braking apparatus for an automotive vehicle has brakes actuatable by fluid pressure to retard motion of the vehicle, an input member movable in response to an operator input to effect a brake actuation, a source of electrical energy, and electrical circuit means for distributing electrical energy. The braking apparatus includes master cylinder means for supplying fluid pressure to the brakes in response to the operator input, fluid pressure responsive booster means for providing a force assisting the operator input, a single fluid pumping means for supplying fluid pressure to the booster means during a brake actuation, and fluid pressure accumulator means for receiving fluid pressure from the fluid pumping means and for supplying fluid pressure to the booster means during a brake actuation.

Diesel engines are increasingly replacing spark-ignition engines as the power source in automobiles. Because diesel engines do not provide a vacuum source with which to operate the vacuum brake boosters previously used with spark-ignition engines, hydraulic brake boosters are frequently used in conjunction with diesel engines. A conventional hydraulic brake booster employs a power steering pump of the vehicle as a source of hydraulic power. However, at the same time that diesel engines are becoming more popular, automobiles are being made smaller in the interest of energy efficiency. Because of their relatively light weight, many small automobiles employ manual steering and do not require power steering. When these small automobiles are equipped with disc brakes, it is desirable to provide a power assist for braking despite the relatively small size of the vehicle. Consequently, a small vehicle with a diesel engine, manual steering, and disc brakes is left without a source of power to provide for power-assisted braking. Accordingly, it has been proposed to drive a vacuum pump or a hydraulic pump from the diesel engine of the vehicle.

The engine-driven pump may power a vacuum or a hydraulic brake booster. However, such an engine-driven pump may cause a parasitic power drag for the vehicle engine. In view of the increasing demand for high fuel mileage and energy-efficient vehicles, such a power drag on the vehicle engine is not desirable. A characteristic which all vehicles have in common, regardless of their size, is an electrical system. Accordingly, an alternative to engine-powered brake boosters may be a brake booster which is powered by the electrical system of the vehicle.

One conventional hydraulic brake booster employs a motor-driven pump as an auxiliary source of hydraulic pressure for the booster. This brake booster employs an engine-driven power steering pump as the primary source of hydraulic power for the brake booster. This brake booster may be a separate unit and not integrated with a master cylinder for the brakes. The master cylinder and the brake booster may not share a single fluid.

Another conventional hydraulic brake booster employs a single fluid with the power steering system. Further, the master cylinder for the brakes and the hydraulic brake booster are integrated into a single housing. However, this booster employs only an engine-driven power steering pump as a source of hydraulic power.

Still another conventional hydraulic brake booster integrates the master cylinder for the vehicle brakes and the hydraulic booster for the master cylinder into a single housing and share a common fluid. Additionally, a motor-driven pump is provided so that the booster may be powered by the electrical system of the vehicle. These brake boosters employ the power steering pump of the vehicle as a primary fluid pressure source and, therefore, cause a parasitic power loss for the vehicle engine.

### SUMMARY OF THE INVENTION

A brake system in accordance with the present invention performs a repeatable brake operation of a vehicle. The brake system includes a main unit having an electrical power circuit, a micro programmable logic controller, an air compressor, a compressed air tank, a pressure regulator, a solenoid valve, and a pneumatic control circuit, a driver control box for controlling the system, and a pneumatic cylinder for performing the repeatable brake operation, the pneumatic cylinder being attached to a brake pedal.

According to another aspect of the system, a proximity sensor detects a position of a clutch pedal.

According to still another aspect of the system, a safety brake pedal pivots a tip of the brake pedal backward to avoid squeezing of a driver's foot when the pneumatic cylinder pushes the brake pedal forward.

According to yet another aspect of the system, a lightgate triggers the repeatable brake operation.

According to still another aspect of the system, the main unit is disposed in a trunk of the vehicle.

According to yet another aspect of the system, the pneumatic cylinder is disposed under a dashboard of the vehicle.

According to still another aspect of the system, a proximity sensor is disposed on a clutch pedal hinge.

A method in accordance with the present invention performs a repeatable brake operation of a vehicle. The method includes the steps of: controlling the method with a main unit having an electrical power circuit, a micro programmable logic controller, an air compressor, a compressed air tank, a pressure regulator, a solenoid valve, and a pneumatic control circuit; controlling the main unit with a driver control box; and repeatedly performing the repeatable brake operation by a pneumatic cylinder attached to a brake pedal.

According to another aspect of the method, a further step includes detecting a position of a clutch pedal by a proximity sensor.

According to still another aspect of the method, a further step includes pivoting a tip of the brake pedal backward to avoid squeezing of a driver's foot when the pneumatic cylinder pushes the brake pedal forward.

According to yet another aspect of the method, a further step includes triggering the repeatable brake operation by an electric eye.

According to still another aspect of the method, a further step includes locating the main unit in a trunk of the vehicle.

According to yet another aspect of the method, a further step includes locating the pneumatic cylinder under a dashboard of the vehicle.

According to still another aspect of the method, a further step includes locating a proximity sensor on a clutch pedal hinge.

An apparatus in accordance with the present invention performs a brake operation of a vehicle. The apparatus includes a main unit having an electrical power circuit, a micro programmable logic controller, an air compressor, a compressed air tank, a pressure regulator, a solenoid valve, and a pneumatic control circuit, a driver control box for controlling the main unit, a proximity sensor disposed on a clutch pedal, and a pneumatic cylinder for performing the brake operation, the pneumatic cylinder being attached to a brake pedal.

According to another aspect of the apparatus, a proximity sensor for detecting a position of a clutch pedal.

According to still another aspect of the apparatus, a safety brake pedal pivots a tip of the brake pedal backward to avoid squeezing of a driver's foot when the pneumatic cylinder pushes the brake pedal forward.

According to yet another aspect of the apparatus, a lightgate triggers the brake operation.

According to still another aspect of the apparatus, the main unit is disposed in a trunk of the vehicle.

According to another aspect of the apparatus, the pneumatic cylinder is disposed under a dashboard of the vehicle.

### BRIEF DESCRIPTION OF THE DRAWINGS

Three ways of carrying out the invention are described in detail below with reference to drawings which illustrate only these three specific embodiments, in which:

FIG. 1 is a fragmentary plan view, partly in cross section, of an automobile for use with the present invention;

FIG. 2 is a schematic view of an example brake mechanism for use with the present invention;

FIG. 3 is a schematic view of another example brake mechanism for use with the present invention; and

FIG. 4 is a schematic view of an example brake system in accordance with the present invention.

### DETAILED DESCRIPTION OF EXAMPLES OF THE PRESENT INVENTION

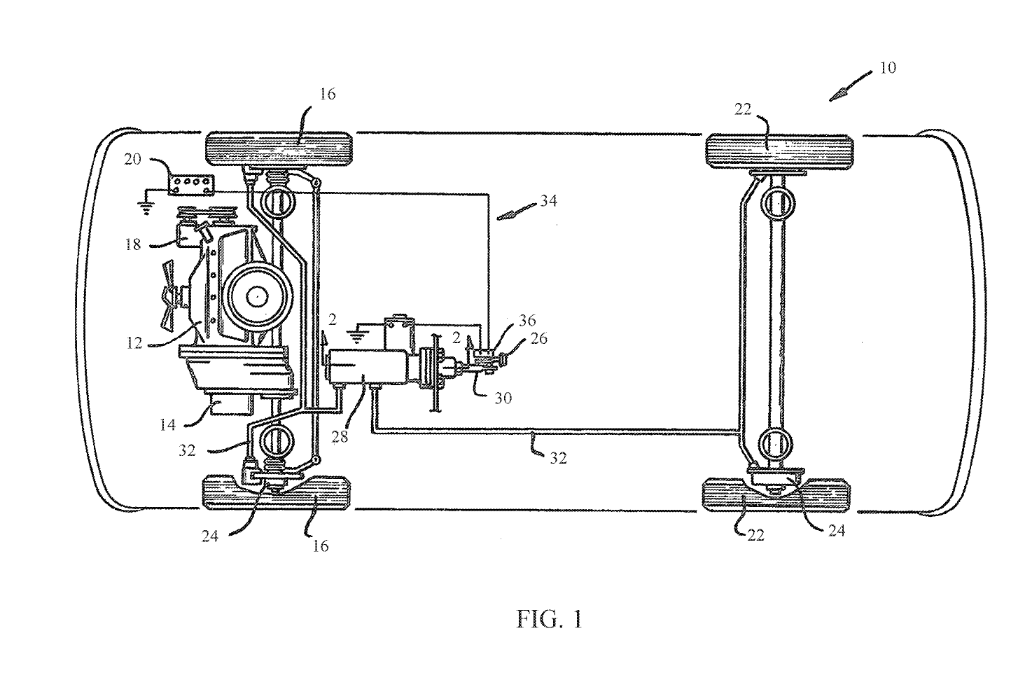

With reference to FIG. 1, an automotive vehicle generally indicated by the numeral 10, may include an engine 12 which drives the automobile via a transmission 14 which is connected to a pair of front dirigible wheels 16. The engine 12 may also drive an alternator 18 to provide electrical power to the automobile 10 via a storage battery 20. The pair of front wheels 16 and a pair of rear wheels 22 may each have a hydraulically actuated brake 24 (only two of which are visible in FIG. 1). In order to effect a brake application, a brake pedal 26 may be disposed in the passenger compartment of the automobile 10. The brake pedal 26 may be operatively connected to a braking apparatus 28 via a rod 30. The braking apparatus 28 may be connected with the brakes 24 via conduits 32. The braking apparatus 28 may also be connected to the storage battery 20 by an electrical circuit 34. A switch 36 in the electrical circuit 34 may be closed in response to movement of the brake pedal 26 to effect a brake application. The electrical circuit 34 may supply electrical energy to the braking apparatus 28 when the switch 36 is closed.

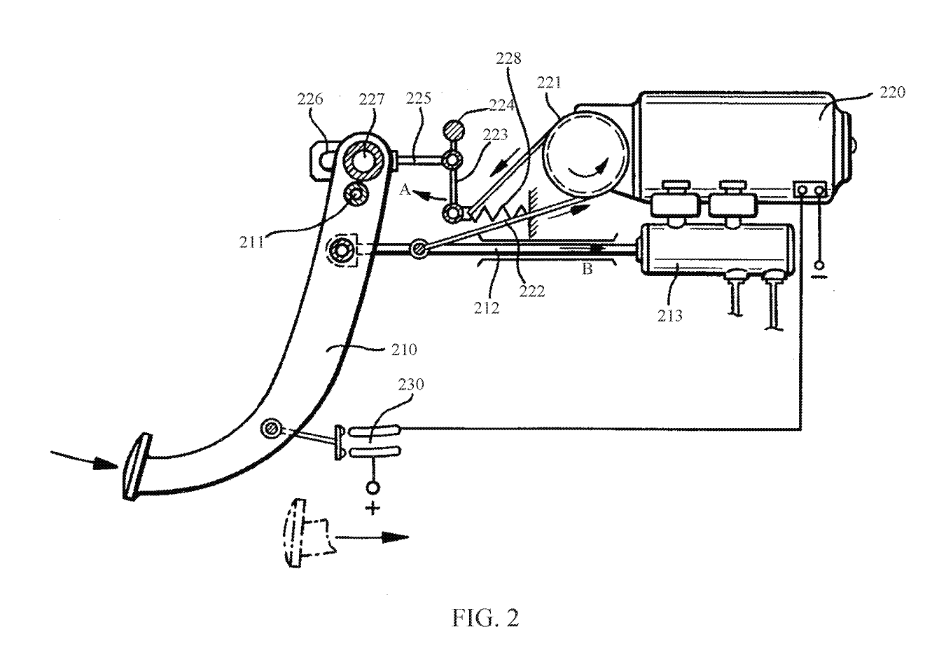

In FIG. 2, another example brake pedal 210 is mounted so that it pivots at 211. To the brake pedal 210, a tappet push rod 212 may actuate a piston in a brake master cylinder 213. An electric motor 220 may provide brake power assistance. The electric motor 220 may drive a friction disc 221 through a suitable speed reduction gear in the direction of rotation. A skid band 222 may cooperate with the friction disc 221. One end of skid band 222 may be fixed to the tappet push rod 212 and its other end to a tensioning lever 223. The tensioning lever 223 may pivot about a point of rotation 224 by a push rod 225. The push rod 225 may have a broader portion with a slot 226 engaging a cam 227 fixed to the brake pedal 210. The tensioning lever 223 may be acted upon by a spring element 228 which pivots the tensioning lever 223 in such a way that the force-locking connection between the friction disc 221 and the skid band 222 is released.

The electric motor 220 may be connected to a voltage source (not shown) via a switch 230 as soon as the brake pedal 210 is actuated. Upon actuation of the brake pedal 210, a low brake pressure may be built up at first in the brake master cylinder 213 via the tappet push rod 212. Simultaneously, the electric motor 220 may be energized. The cam 227 may be displaced in the slot 226 of the push rod 225. Thus, brake pressure may not be augmented at the beginning of the braking process.

When, however, the brake pedal 210 is pressed such that the push rod 225 and thereby the tensioning lever 223 are displaced in the direction of arrow A against the force of the spring element 228, the skid band 222 may be stretched. The torque of the electric motor 220 may now be transmitted to the skid band 222 by the friction disc 221. The tappet push rod 212 may be displaced in the direction of arrow B and, thus, the brake pressure in the brake master cylinder 213 may be intensified. Thus, the skid band 222 and the friction disc 221 may form a force-locking coupling whereby the frictional connection corresponds to the pressure applied to the brake pedal 210. The coupling via the skid band 222 and the friction disc 221 may act only in one direction, that is, from the electric motor 220 to the tappet push rod 212 and, hence, to the brake pedal 210.

Further, the tappet push rod 212 may also be actuated without any handicap when the electric motor 220 is defective and the friction disc 221 is blocked. In this example, the electric motor 220 start before its torque intensifies the overall brake system. Because of the slot 226, the pivoting of the tensioning lever 223 and the push rod 225 may have a predefined clearance. When the brake pedal 210 is reset, the spring element 228 may adjust the tensioning lever 223 in such a way that the frictional connection between the friction disc 221 and the skid band 222 is released and, thus, does not act against the reset of the tappet push rod 212 via the still running electric motor 220.

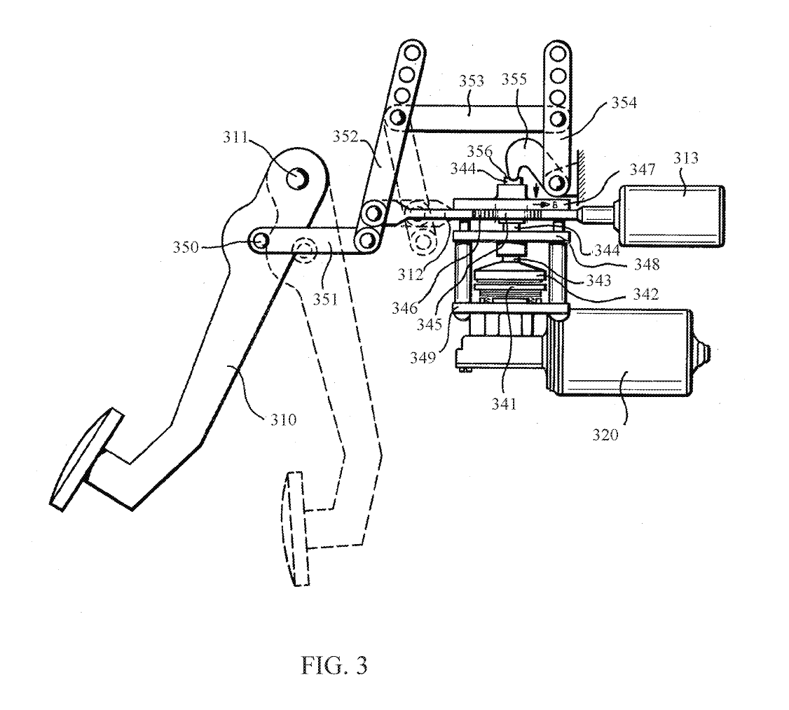

In FIG. 3, still another example electric motor 320 may drive a first friction disc 341 which cooperates with a second friction disc 342. A shaft 344 with a pinion 345 may be coupled with the second friction disc 342 via an overrunning-clutch drive 343. The pinion 345 may cooperate with a toothed rack 346 which simultaneously serves as a tappet push rod for actuating a piston in the brake master cylinder 313. The two friction discs 341, 342 may work together as a coupling axially adjustable towards each other. These parts may be held in a bearing cage with two drive end shields 347, 348 and a mounting plate 349 all bolted to each other.

A four-bar mechanism may include levers 351, 352, 353, 354 attached to a pivot 350 on the brake pedal 310. A driven rocking arm 355 may be connected with the lever 354 in a manner that prevents twisting. The driven rocking arm 355 may press on the front side of the shaft 344. Thus, circular movement of the pivot 350 via the four-bar mechanism may provide axial movement of the shaft 344 and the second friction disc 342 via the overrunning-clutch drive 343.

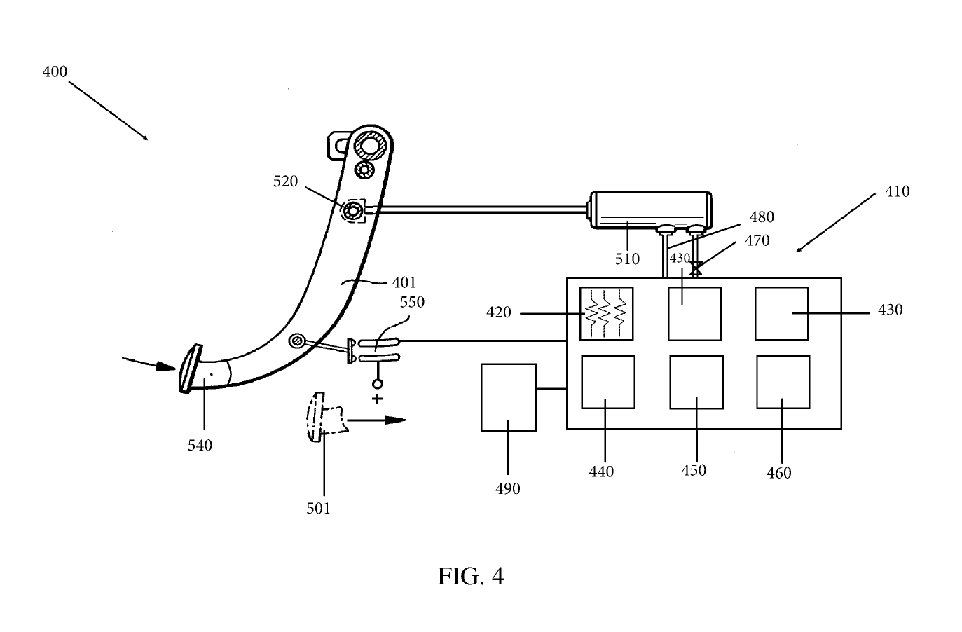

As shown in FIG. 4, a pneumatic brake system 400 in accordance with the present invention may press a brake pedal 401 of a vehicle in order to perform repeatable, full stop braking. Repeatable here means always braking at the same spot with the same force and speed on the brake pedal 401, which may not be achieved by a human driver braking with his foot. The system 400 may include a main unit 410 containing electrical power circuits 420, a micro programmable logic controller 430, an air compressor 440, a compressed air tank 450, a pressure regulator 460, a solenoid valve 470, and a pneumatic control circuit 480. All these components may be contained in an aluminum housing. The main unit 410 may be installed in a vehicle trunk. A driver control box 490 for the system 400 may include indicators and pushbuttons that a driver may use to control the system. The driver control box 490 may be installed next to the driver's seat of the vehicle.

A pneumatic cylinder 510 may be installed underneath the vehicle dashboard and may be attached to the brake pedal 401 by a hinged bracket 520. A proximity sensor 530 may be installed on a clutch pedal hinge for detecting the position of the clutch pedal 501. A safety brake pedal 540 with an additional hinge may be added to the brake pedal 401 for pivoting the tip of the brake pedal backward to avoid squeezing of the driver's foot when the pneumatic cylinder 510 pushes the brake pedal forward. A lightgate, or electric eye 550, may be connected to the main unit 410 to trigger the braking action. The system 400 may be used for brake performance tests with passenger vehicles and/or all tests that require a repeatable full stop, or emergency, brake operation.

The system requires no removal of the passenger seat, no second brake pedal on the passenger side, and no air refill from external compressed air supply (the integrated compressor provides this). The system may further interlock braking with clutch pedal position.

It can be seen from the above description that such a power brake system may be installed into motor vehicles at a later time, because it represents a compact constructional unit. Thus, only slight changes may be made at the tappet push rod and at the brake pedal for attaching the lever transmission mechanism. While the above principles of the present invention describe a connection with a specific apparatus, it is to be clearly understood that this description is made only by way of example and not as a limitation to the scope of the present invention as set forth in the objects thereof and in the accompanying claims.

What is claimed:

1. A brake system for performing a repeatable brake operation of a vehicle comprising:
a main unit having an electrical power circuit, a micro programmable logic controller, an air compressor, a compressed air tank, a pressure regulator, a solenoid valve, and a pneumatic control circuit;
a driver control box for controlling the system; and
a pneumatic cylinder for performing the repeatable brake operation, the pneumatic cylinder being attached to a brake pedal.

2. The brake system as set forth in claim 1 further including a proximity sensor for detecting a position of a clutch pedal.

3. The brake system as set forth in claim 1 further including a safety brake pedal for pivoting a tip of the brake pedal backward to avoid squeezing of a driver's foot when the pneumatic cylinder pushes the brake pedal forward.

4. The brake system as set forth in claim 1 further including a lightgate for triggering the repeatable brake operation.

5. The brake system as set forth in claim 1 wherein the main unit is disposed in a trunk of the vehicle.

6. The brake system as set forth in claim 1 wherein the pneumatic cylinder is disposed under a dashboard of the vehicle.

7. The brake system as set forth in claim 1 wherein a proximity sensor is disposed on a clutch pedal hinge.

8. A method for performing a repeatable brake operation of a vehicle, the method comprising the steps of:
controlling the method with a main unit having an electrical power circuit, a micro programmable logic controller, an air compressor, a compressed air tank, a pressure regulator, a solenoid valve, and a pneumatic control circuit;
controlling the main unit with a driver control box; and
repeatedly performing the repeatable brake operation by a pneumatic cylinder attached to a brake pedal.

9. The method as set forth in claim 8 further including the step of detecting a position of a clutch pedal by a proximity sensor.

10. The method as set forth in claim 8 further including the step of pivoting a tip of the brake pedal backward to avoid squeezing of a driver's foot when the pneumatic cylinder pushes the brake pedal forward.

11. The method as set forth in claim 8 further including the step of triggering the repeatable brake operation by an electric eye.

12. The method as set forth in claim 8 further including the step of locating the main unit in a trunk of the vehicle.

13. The method as set forth in claim 8 further including the step of locating the pneumatic cylinder under a dashboard of the vehicle.

14. The method as set forth in claim 8 further including the step of locating a proximity sensor on a clutch pedal hinge.

15. An apparatus for performing a brake operation of a vehicle comprising:
a main unit having an electrical power circuit, a micro programmable logic controller, an air compressor, a compressed air tank, a pressure regulator, a solenoid valve, and a pneumatic control circuit;
a driver control box for controlling the main unit;
a proximity sensor disposed on a clutch pedal; and
a pneumatic cylinder for performing the brake operation, the pneumatic cylinder being attached to a brake pedal.

16. The apparatus as set forth in claim 15 further including a proximity sensor for detecting a position of a clutch pedal.

17. The apparatus as set forth in claim 15 further including a safety brake pedal for pivoting a tip of the brake pedal backward to avoid squeezing of a driver's foot when the pneumatic cylinder pushes the brake pedal forward.

18. The apparatus as set forth in claim 15 further including a lightgate for triggering the brake operation.

19. The apparatus as set forth in claim 15 wherein the main unit is disposed in a trunk of the vehicle.

20. The apparatus as set forth in claim 15 wherein the pneumatic cylinder is disposed under a dashboard of the vehicle.
